(19) United States
(12) Patent Application Publication
(10) Pub. No.: US 2020/0161678 A1
(43) Pub. Date: May 21, 2020

(54) HUMIDIFYING MODULE FOR HUMIDIFYING A FLUID

(71) Applicant: Mahle International GmbH, Stuttgart (DE)

(72) Inventors: Swen-Juri Bauer, Stuttgart (DE); Winfried Brand, Stuttgart (DE); Samuel Kohler, Weil im Schoenbuch (DE); Aleksandar Radlovic, Stuttgart (DE); Lukas Schikora, Esslingen (DE)

(21) Appl. No.: 16/686,093

(22) Filed: Nov. 15, 2019

(30) Foreign Application Priority Data
Nov. 16, 2018 (DE) 10 2018 219 695.8

(51) Int. Cl. H01M 8/04119; B01D 69/08; B01D 53/26; B01D 21/00; H01M 8/04291; H01M 8/04828

(52) U.S. Cl. CPC H01M 8/04149; B01D 69/08; B01D 53/268; H01M 2250/20; H01M 8/04291; H01M 8/04835; H01M 8/0485; B01D 21/0042

(57) ABSTRACT

A humidifying module for humidifying a fluid, such as an operating fluid of a fuel cell of a motor vehicle, is disclosed. The humidifying module includes a humidifier block including a plurality of first fluid paths through which a first fluid is flowable and a plurality of second fluid paths through which a second fluid is flowable. The plurality of first fluid paths and the plurality of second fluid paths in the humidifier block are fluidically separated from each other via a plurality of gas-tight and humidity-permeable membranes. A liquid separator is provided that is fluidically connected to one of the first fluid paths for flow-through with the first fluid and the second fluid paths for flow-through with the second fluid.

### CROSS-REFERENCE TO RELATED APPLICATION

This application claims priority to German Application No. DE 10 2018 219 695.8 filed on Nov. 16, 2018, the contents of which are hereby incorporated by reference in its entirety.

### TECHNICAL FIELD

The invention relates to a humidifying module for humidifying a fluid, in particular for humidifying an operating fluid of a fuel cell, in particular in a motor vehicle comprising a fuel cell, as well as a membrane liner for such a humidifying module.

### BACKGROUND

Conventional devices for humidifying a fluid, hereinafter referred to as humidifying modules, have been known for some time. According to the prior art, such humidifying modules comprise membranes, which are impermeable for gas and which are permeable for humidity or water, respectively, or water vapor. In the humidifying module, a fluid to be humidified on the one hand, and a humid medium on the other hand, in each case flows over a membrane, which is formed in this way. The two fluids are thereby fluidically separated from one another by means of the membrane. A mixing of the two fluids, which flow through the humidifying module and which flow over the membrane liners, in terms of material, thus does not occur.

However, the humidity of the fluid, which has a higher humidity, can pass through the membrane and can be absorbed by the fluid having a lower humidity for the humidification thereof. The humidity of the two fluids thus adapts. In particular the process fluids of a fuel cell have to be humidified by means of such a humidifying module. The process fluids used in fuel cells, for example molecular hydrogen and oxygen, have to be humidified prior to flowing into the fuel cell, because the polymer electrolyte membranes, which are typically used in a fuel cell, would otherwise dry out. Such a dry-out, which can be avoided by means of the humidifying module, negatively impacts in particular the durability of the polymer electrolyte membranes as well as the efficiency of the fuel cell.

A humidifying module is known from DE 20 2013 003 566 U1, which can be used to humidify process gases for fuel cells. This humidifying module comprises a water-permeable and essentially gas-impermeable water transfer layer. The humidifying module furthermore has a thermoplastic protective layer, which is water- and gas-permeable at least in some areas. Towards its upper and lower side, the water transfer layer is fixedly connected to an afore-mentioned thermoplastic protective layer by means of a thermopressing process, so that a three-layered sandwich is formed. The water transfer layer and the protective layer are arranged in a stack so as to at least partially overlap one another. To humidify a process gas for a fuel cell, said process gas is guided past a side of the water transfer layer, and a further humid gas on the other side of the water transfer layer. Due to the water transfer layer, a humidity compensation can take place between the two gases, so that the humdities of the process gas as well as of the second gas adapt to one another.

A humidifying module is furthermore known from DE 10 2008 034 407 A1, which can be used to humidify a fluid in a fuel cell system of a motor vehicle. This humidifying module has two housing parts, between which at least one gas-tight and humidity-permeable membrane is arranged in a housing comprising the same membrane. This housing comprising the membrane is formed in the form of a cartridge and seals the membrane against the environment. To humidify a process fluid, which is supplied to the fuel cell and which flows past the membrane on the other side thereof, the humidity of a second fluid, which flows past the membrane on the other side thereof, can pass through the membrane by means of the humidifying module and can be absorbed by the process fluid of the fuel cell, without resulting in a mixing of the two fluids in terms of the material.

It is to thereby be considered to be a disadvantage of the known solutions that it is difficult to seal the membranes against the environment, so that a housing, which seals the membrane liners, is used for the most part. Even though there are also solutions, in the case of which such a housing can be forgone, sealing concepts used in the case of the afore-mentioned solutions prove to be comparatively cost-intensive. In addition, it has been shown that with conventional humidifying modules, the effectiveness of the gas-tight and humidity-permeable membranes used for humidity exchange is impaired if the humid fluid carries such a large amount of humidity that liquid is deposited on the membranes. Any liquid droplets carried along by the fluid can also deposit on the membranes, unduly reducing the effective area of the membranes.

### SUMMARY

It is thus an object of the present invention to show new ways in the development of humidifying modules for humidifying a fluid—in particular for eliminating the above-mentioned disadvantages.

This object is solved by means of the subject matter according to the independent patent claim(s). Preferred embodiments are subject matter of the dependent patent claims.

It is thus the basic idea of the invention to embody a humidifying module for humidifying a fluid with a humidifier block, in which first fluid paths through which the first fluid can flow for the exchange of humidity between a first and a second fluid and second fluid paths through which the second fluid can flow are fluidically separated from one another by means of gas-tight and humidity-permeable membranes, and with a liquid separator fluidically connected either to the first fluid paths or to the second fluid paths and thus through which the first or the second fluid can flow. The membranes thereby limit first and second fluid paths, which are fluidically separated from one another and through which two fluids can flow in such a way, that a humidity exchange between the fluids can take place through the membranes, without resulting in a mixing of the fluids in terms of material. The liquid separator also prevents the first or second fluid flowing through the liquid separator from having too much humidity or too much liquid. The liquid separator acts either as a pre-separator, so that a reduction in the effective area of the membranes that can be used for humidity exchange can be reduced or even completely avoided, or as a post-separator, so that the humidity or liquid carried along with the first or second fluid after flowing through the humidifier block can be prevented or at least reduced from escaping into the environment.

A humidifying module according to the invention for humidifying a fluid, preferably for humidifying an operating fluid of a fuel cell, particularly preferably in a motor vehicle with a fuel cell, comprises a humidifier block in which first fluid paths through which a first fluid can flow and second fluid paths through which a second fluid can flow are present. In the humidifier block, the first and second fluid paths are fluidically separated from each other by using gas-tight and humidity-permeable membranes. The membranes allow humidity exchange between the first and second fluids without material mixing of the first and second fluids. The humidifying module also comprises a (first) liquid separator which is fluidically connected to either the first or second fluid paths for passage of the first or second fluid. It is therefore advantageous to avoid too much humidity or too much liquid in the first or second fluid flowing through the separator, which, as already indicated, can ensure the effectiveness of the membranes or protect the environment.

According to a preferred embodiment of the humidifying module, the first liquid separator is fluidly connected to the same first or second fluid paths at a first end portion of the first or second fluid paths. The humidifying module also has a second fluid separator which is fluidly connected to the same first or second fluid paths in a second end portion of the first or second fluid paths connected to the first fluid separator opposite the first end portion. Depending on the direction of flow, the first fluid separator acts as a pre-separator and the second fluid separator as a post-separator or vice versa. This has the advantage that both the effectiveness of the membranes can be ensured and the unwanted introduction of humidity or liquid into the environment can be avoided or at least reduced.

The humidifying module expediently comprises further liquid separators which are preferably fluidically connected to the respective other end sections of the first and second fluid paths which are not already fluidically connected to the first or second liquid separator. The advantage of this is that the humidity or the liquid content of both the first and the second fluid can be limited to an optimum value.

According to a further advantageous embodiment of the humidifying module, at least one of the liquid separators has a fin structure in its separator interior. This fin structure serves to separate liquid from the first or the second fluid, respectively. The fin structure comprises a plurality of fins, which are spaced apart from one another. The fluid, which flows through the liquid separator, is deflected at the fins, and, as a result of the inertia of the liquid droplets entrained by this fluid, the afore-mentioned droplets are separated from the fluid stream. Liquid can thus be separated from the respective fluid by means of a comparatively simple construction. In terms of costs, a suitable separation of liquid from the respective fluid can also be ensured thereby to protect the environment or to protect the functionality of the membranes of the membrane liners.

In the case of a further preferred embodiment of the humidifying module, a nozzle plate comprising a first acceleration opening is arranged in the separator interior of one of the liquid separators. This nozzle plate divides the separator interior into two subregions. The first or the second fluid, depending on which one flows through the liquid separator, is accelerated through the first acceleration opening of the nozzle plate, and is directed towards a deflector plate, which is also arranged in the separator interior. The accelerated first or second fluid thus hits the deflector plate. As a result of the abrupt change in direction of the flow of the first or second fluid and as a result of the inertia of possible liquid droplets, which are entrained in this first or second fluid, the afore-mentioned droplets are separated from the fluid. A particularly effective liquid separation can thereby be attained in an advantageous manner.

According to a further advantageous embodiment of the humidifying module, the nozzle plate is embodied with at least one second acceleration opening. This second acceleration opening can be at least partially closed by means of a settable closure element. The second acceleration opening can thus be connected or disconnected. Due to this connection or disconnection of the second acceleration opening, the volume flow of the first or second fluid flowing through the respective liquid separator can thus be set. The level of separation can thus also be influenced. It can thus be ensured in an advantageous manner that an amount of liquid, which is as optimal as possible, is separated from the respective fluid.

According to a further advantageous embodiment of the humidifying module, at least one of the liquid separators comprises an insert member, which particularly preferably has a liquid outlet. A particularly good accessibility of the respective liquid separator or of its interior, respectively, is attained, for example for maintenance purposes, by means of this insert member in an advantageous manner.

In another advantageous further embodiment of the humidifying module, the membranes of the humidifier block are essentially flat and arranged in a membrane stack. Such membranes offer a particularly cost-effective way of constructing the humidifier block.

The humidifier block of the humidifying module is conveniently equipped with a plurality of first and second membrane liners, which are arranged so as to alternate along a stack direction at a distance from one another. Two of these membrane liners, which are adjacent in the stack direction, in each case alternately limit one of the first fluid paths and one of the second fluid paths, wherein the first fluid path is arranged fluidically separated from the second fluid path. The first fluid path is formed in such a way that a first fluid can flow through it. The second fluid path is formed in such a way that a second fluid can flow through it. The membrane liners each comprise a holding part, wherein the first membrane liners each have a first holding part, and the second membrane liners each have a second holding part. One of the gas-tight and humidity-permeable membranes is arranged at this holding part of each membrane liner. The first fluid path is in each limited on the one side of the afore-mentioned membrane, and the second fluid path on the other side by means of this membrane. First and second fluid path are thus separated from one another by means of the gas-tight and humidity-permeable membrane. If the first fluid has a higher humidity than the second fluid, a transition of the humidity of the first fluid for humidifying the second fluid through the gas-tight and humidity-permeable membrane can thus take place when flowing through the humidifying module. A first fluid distribution duct for distributing the first fluid to the first fluid paths, and a first fluid collector duct for collecting the first fluid after flowing through the first fluid paths, are formed in the membrane liners or in the stack of the membrane liners, respectively. Analogous thereto, a second fluid distribution duct for distributing the second fluid to the second fluid paths, and a second fluid collector duct for collecting the second fluid after flowing through the second fluid paths, are formed in the membrane liners or in the stack of the membrane liners, respectively. It proves to be advantageous thereby that the fluid distributor as well as collectors as well as the fluid paths are arranged in the membrane liners or in the stack of the membrane liners, respectively, whereby in particular the number of necessary component parts for the humidifying module and thus also the expected production costs are reduced.

The membrane liners of the humidifier block in the stack of membrane liners are arranged fluid-tight to each other. This has the advantage that a separate housing enclosing the membrane stack and sealing it from an external environment surrounding the humidifier block can be completely dispensed with. However, such a housing can of course be provided to protect the membrane stack and the typically fragile membranes from external interference or to improve the necessary sealing of the membrane liners against this environment.

Two first apertures are in each case preferably present in each first holding part for forming the first fluid distribution duct and for forming the first fluid collector duct. Each first holding part furthermore comprises two second apertures for forming the second fluid distribution duct and for forming the second fluid collector duct. This means that the fluid distribution and fluid collector ducts are each formed by the first or second apertures, respectively, in some sections. All of the second holding parts each have two first apertures for forming the second fluid distribution duct and for forming the second fluid collector duct. Two second apertures are furthermore in each case arranged in each second holding part for forming the first fluid collector duct and the first fluid distribution duct. The first and second apertures of the first and second holding parts thus each form sections of the fluid distribution ducts or of the fluid collector ducts, respectively. This formation of the membrane liners or of the holding parts, respectively, provides a particularly installation space-saving option for designing the humidifying module in an advantageous manner, because all of the fluid-guiding cavities are formed in the membrane liners or the stack of the membrane liners, respectively. There are also cost advantages, because additional component parts, which include the fluid distribution ducts or the fluid collector ducts, respectively, can be forgone.

According to a preferred embodiment of the humidifying module according to the invention, the membrane liners or the stack of membrane liners, respectively, are arranged between a first and a second closure part. The first as well as the second closure part each have a first and a second fluid connection for the first or the second fluid, respectively. The first fluid connection of the first closure part is thereby fluidically connected to the first fluid distribution duct. The second fluid connection of the first closure part is connected to the second fluid distribution duct so as to fluidically communicate therewith. Vice versa, the first fluid connection of the second closure part is connected to the second fluid collector duct so as to fluidically communicate therewith, and the second fluid connection of the second closure part is connected to the first fluid collector duct so as to fluidically communicate therewith. The fluid connections of the first or of the second closure part can be equipped with identical outside diameters or with standardized couplings, respectively, in an advantageous manner, whereby the humidifying module can be integrated in higher-level systems with comparatively little effort.

According to a further preferred embodiment of the humidifying module, at least two membrane liners, which are adjacent in the stack direction, are tightly connected to one another. The first and the second fluid collector duct as well as the first and the second fluid distribution duct are thereby also sealed against the external environment of the humidifying module. Advantageously, a separate housing, which seals the membrane liners or the first and the second fluid collector duct, respectively, as well as the first and the second fluid distribution duct, can thereby be foregone. Direct cost advantages can be derived from this foregoing of a separate housing.

A further preferred embodiment of the humidifying module provides that at least two holding parts, which are adjacent in the stack direction, of the respective membrane liners are tightly connected to one another by means of a press connection. An additional sealing medium, such as, for example, an adhesive is thus advantageously not required in order to seal the holding parts or the membrane liners, respectively, which include the fluid paths as well as the fluid collectors and fluid distributors, against the environment. Such a press connection is furthermore releasable, which is advantageously associated with the fact that the sealed component parts can optionally be separated from one another, without having to destroy the afore-mentioned component parts. On the one hand, this serves to save costs, because, first of all, the sealing medium can be forgone, and, secondly, because the membrane liners can readily be used again after a possible disassembly of the humidifying module, for example for maintenance purposes.

According to a preferred embodiment of the humidifying module, the membrane liners between the two closure parts are pressed by means of a screw connection. The screw connection is thereby formed between the two closure parts. To form this screw connection, the closure parts have, for example, a through-bore, through which a threaded rod is guided. The membrane liners can also have through-bores, which are embodied or arranged, respectively, according to a hole pattern, which is congruent with the closure part. The pressing force for sealing the holding parts or the membrane liners, respectively, or the humidifying module, respectively, is attained by means of a counter-screwing of screw nuts, starting at the two ends of the threaded rods.

It is also possible to design the screw connection for example by the use of a long screw, which has a screw head on one side, the bearing surface of which has a larger diameter than the diameter of the through-bore. To apply the sealing pressing force, only a nut is then screwed onto this screw. One of the closure parts can also have a threaded bore or an insert comprising a thread, instead of a through-bore. A large variety of further options for forming such a screw connection are known to the pertinent person of skill in the art, which is why a more detailed description is foregone at this point. The establishing of the press connection for sealing the adjacent holding parts or membrane liners, respectively, can be realized particularly cost-efficiently and in an easily producible manner with the use of such a screw connection.

In the case of a preferred embodiment of the humidifying module, the two closure parts are formed as identical parts. The first and second membrane liners can also be embodied as identical parts. This results in cost advantages, because the identical parts can each be produced by means of identical manufacturing processes and also on identical manufacturing lines or in series, respectively.

In the case of a further preferred embodiment of the humidifying module, the first and the second fluid paths of the humidifying module are formed in such a way that the first and the second fluid flows through them in cross-flow during operation of the humidifying module. This is to be understood in such a way that, viewed in a stack direction, the flow direction of the first fluid through the first fluid paths intersects a flow direction of the second fluid through the second fluid paths. A particularly good humidity exchange between the two fluids is attained thereby in an advantageous manner by means of the gas-tight and humidity-permeable membrane.

A further advantageous embodiment of the humidifying module provides that the holding part of at least one membrane liner is formed as plate-like holding frame. The afore-mentioned plate-like holding frame has a central aperture. This central aperture in the plate-like holding frame is closed by means of the gas-tight and humidity-permeable membrane. The central aperture is arranged laterally between the two first apertures. The two first apertures are thereby arranged at a distance from one another along a first transverse direction. This first transverse direction runs orthogonally to the stack direction. The plate-like formation of the holding frame of the holding part of a membrane liner results in a particularly good stackability of the membrane liners, whereby they can also be connected tightly particularly well by means of the already described press connection.

According to a further advantageous embodiment of the humidifying module, this central aperture is arranged laterally between the two second apertures. The two second apertures are arranged at a distance from one another along a second transverse direction. The second transverse direction also runs orthogonally to the stack direction, but not congruent to the first transverse direction. It is attained thereby in an advantageous manner that the gas-tight and humidity-permeable membrane is flown over across an effective length, which is a large as possible. The humidity exchange can thus be realized particularly well by means of the gas-tight and humidity-permeable membrane.

In the case of a further preferred embodiment, the first apertures in the holding part are each fluidically connected to the central aperture so as to communicate therewith by means of a first connecting section. The two second apertures can also each be fluidically connected to the central aperture so as to communicate therewith by means of a connecting section. By means of these connecting sections, a distribution of the first or of the second fluid, respectively, to the first or second fluid paths, respectively, as well as a collecting of the first or second fluid, respectively, from the first or second fluid paths, respectively, can take place particularly easily after the fluids have flown through the fluid paths.

In the case of an advantageous further development of the humidifying module, the two first connecting sections are formed to be open towards an upper side of the holding part. The two second connecting sections can analogously be formed to be open towards a lower side of the holding part. This embodiment of the connecting sections or of the holding parts, respectively, can be produced with particularly little effort, which is thus associated with manufacturing cost advantages.

In the case of a further advantageous embodiment of the humidifying module, a sealing surface of the first closure part as well as a sealing surface of the second closure part and a cross section of at least one of the membrane liners, viewed in the stack direction, have an essentially identical outer contour. All membrane liners particularly preferably have such an essentially identical outer contour, viewed in the stack direction. A particularly compact outer shape of the humidifying module can thus be attained in an advantageous manner, whereby said humidifying module can thus be integrated particularly well and in a space-saving manner in a higher-level system.

According to a further preferred embodiment of the humidifying module, this contour is axially- or point-symmetrical. It is thereby ensured in an advantageous manner that the force, which is applied by means of the screw connection to sealingly press the membrane liners between the connecting parts, is distributed as evenly as possible to all membrane liners as well as the closure parts or the sealing surfaces thereof, respectively. Membrane liners, which are embodied as identical parts, can thus also be arranged in the stack so as to be rotated relative to one another in such a way that, depending on their alignment, they either form a first membrane liner or a second membrane liner.

In the case of a further preferred embodiment of the humidifying module, the first closure part has a bypass fluid duct, which can be closed at least partially. This bypass fluid duct can be closed at least partially by means of an adjustable valve device. The bypass fluid duct connects either the first or the second fluid connection of the first closure part to the first or the second fluid collector duct as to fluidically communicate therewith, past the first or second fluid paths, respectively, so. The second closure part can also comprise such a bypass fluid duct comprising an adjustable valve device, which can at least partially close the afore-mentioned bypass fluid duct. This bypass fluid duct of the second closure part connects either the first or the second fluid connection past the first or second fluid paths, respectively to either the first or the second fluid distribution duct so as to fluidically communicate therewith. The bypass fluid duct of the first closure part or the bypass fluid duct of the second closure part, respectively, thus serves to bridge the first or second fluid paths, respectively. In the case that the adjustable valve device is open, a flow-through of the fluid paths and thus also a humidity exchange between the first and the second fluid thus does not occur. It follows as an advantage from this that the level of the humidification of one of the first or of the second fluid, depending on which one is the fluid, which is to be humidified, can be set by means of the at least partial closing of the respective bypass fluid duct by means of the adjustable valve device. The setting of the valve device can take place during the operation of the humidifying module and continuously. It can be ensured thereby that the fluid to be humidified always has an optimal level of humidity.

In the case of a further advantageous embodiment of the humidifying module, a first liquid separator is arranged between the sealing surface of one of the first or of the second closure part as well as the upper or lower side facing the same first or second closure part of the closest membrane liner. This first liquid separator has a separator interior, which connects the first fluid connection of the first or second closure part to the first fluid distribution duct so as to fluidically communicate therewith. The first liquid separator can also be an integral part of the respective first or second closure part. A second liquid separator can be arranged between the sealing surface of the respective other one of the first or second closure part as well as the upper or lower side of the closest membrane liner facing the same other first or second closure part. This second liquid separator has a separator interior, which connects the second fluid connection of this other one of the first or second closure part to the first fluid collector duct so as to communicate therewith. The second liquid separator can also be an integral part of this other one of the first or of the second closure part. It can advantageously be prevented in this way that liquid drops, which are too large, reach into the first or second fluid paths, respectively, with the humid fluid and wet the membranes of the membrane liners there, whereby the efficiency thereof would be impacted. It can thus be ensured by means of the first liquid separator that the function of the humidifying module is also ensured when the humid fluid entrains liquid comprising a droplet size, which is too large. The second liquid separator advantageously serves the purpose that prior to the escape of the humid fluid, the liquid entrained by this fluid can be separated. It is thus prevented that liquid reaches into the surrounding area in an unwanted manner.

According to a further advantageous embodiment of the humidifying module, the gas-tight and humidity-permeable membranes arranged in the humidifier block of the humidifying module are designed as hollow-fiber membranes. Such hollow-fiber membranes enable a particularly effective humidity exchange between the first and the second fluid.

The humidity-permeable and gas-tight membranes of the humidifier block, which are designed as hollow-fiber membranes, each enclose a cavity. The cavities of the membranes each form one of the first fluid paths. The cavities of the hollow-fiber membranes can therefore be flowed through by the first fluid along the first fluid paths. The hollow-fiber membranes limit the second fluid paths at outer sides of the hollow-fiber membranes facing away from the cavities. This means that the second fluid paths are defined by spaces between the hollow-fiber membranes. As the fluid flows through the second fluid paths, the second fluid flows around the outer sides of the hollow-fiber membranes. The advantage of this is that it is particularly easy to constructively separate the first and second fluid paths in the humidifier block of the humidifying module using the hollow-fiber membranes.

In the case of an advantageous embodiment of the humidifying module, the hollow-fiber membranes of the humidifier block extend along a common longitudinal direction and are arranged essentially parallel and at a distance from each other. This results in a particularly uniform arrangement of the hollow-fiber membranes, which has a positive effect on the effectiveness of the humidifying module due to the particularly uniform formation of the second fluid paths.

Another preferred further embodiment of the humidifying module is that the humidifier block of the humidifying module has a housing which extends in the longitudinal direction to delimit a housing interior. The housing interior comprises a central chamber as well as a fluid distributor chamber and a fluid collector chamber. The central chamber of the housing interior is fluidically separated from the fluid distributor chamber of the housing interior and the fluid collector chamber of the housing interior by means of two sealing plates lying opposite each other in the longitudinal direction. This implies that the central chamber of the housing interior is arranged in the longitudinal direction between the fluid collector chamber of the housing interior and the fluid distributor chamber of the housing interior. The hollow-fiber membranes each have two end sections which lie opposite each other in the longitudinal direction and which each merge into a central section of the respective hollow-fiber membranes arranged between the end sections. The hollow-fiber membranes are arranged in the interior of the housing in such a way that the central section of the hollow-fiber membranes limits the second fluid paths on the outside of the hollow-fiber membranes in the central chamber of the interior of the housing. This means that the second fluid paths are present in the central chamber of the housing interior. The housing as well as the two sealing plates and the outer sides of the hollow-fiber membranes conveniently limit the second fluid paths in a fluid-tight manner. The two end sections of one of the hollow-fiber membranes each penetrate one of the sealing plates, so that the fluid distributor chamber and the fluid collector chamber are fluidically connected via the cavities of the hollow-fiber membranes, which form the first fluid paths. The first fluid can thus be distributed via the fluid distributor chamber to the cavities of the hollow-fiber membranes forming the first fluid paths and collected again via the fluid collector chamber after flowing through the first fluid paths. The humidity exchange through the humidity-permeable and gas-tight hollow-fiber membranes takes place in the central chamber of the housing. Such a design of the humidifier block of the humidifying module allows a particularly efficient humidity exchange between the first and the second fluid.

In the case of a further preferred embodiment of the humidifying module, a spacer device is attached to the membrane of a membrane liner. This spacer device ensures that the membrane is also secured in its position during operation of the humidifying module. The membrane as well as the spacer device of this membrane liner can be fixedly connected to the holding part. This fixed connection is particularly preferably attained by means of a screen printing process or by means of high-frequency welding. The position of the typically flexurally limp membrane is also ensured during operation of the humidifying module by means the spacer device in an advantageous manner. It is thus prevented that for example the membrane, which is provided with the spacer device, comes into contact with the membrane of the closest membrane liner. On the one hand, such a contact would possibly damage the membrane, and, on the other hand, reduce the effective surface for the humidity exchange via the membrane.

The scope of the present invention furthermore extends to a membrane liner for a humidifying module, preferably for a humidifying module as already described above.

A membrane liner according to the invention thus comprises a holding part, at which a gas-tight and humidity-permeable membrane is arranged. The holding part furthermore has two first apertures as well as two second apertures. The holding part is formed as plate-like holding frame, which has a central aperture. The membrane closes the afore-mentioned central aperture in a gas-tight and liquid-permeable manner. In the case of such a membrane liner according to the invention, the holding part can be produced particularly cost-efficiently due to its plate-shaped design, because common semi-finished products can be fallen back on.

A preferred embodiment of the membrane liner provides that the central aperture is arranged laterally between the two first apertures. These two first apertures are spaced apart from the central aperture. The two first apertures and the central aperture are arranged along a first transverse direction of the plate-shaped holding part. Analogously, the central aperture is arranged laterally between the two second apertures. The two second apertures are arranged spaced apart from the central aperture. The two second apertures as well as the central aperture are arranged along a second transverse direction of the plate-shaped holding part. A particularly good stackability of the membrane liners results due to the plate-like formation of the holding frame of the holding part of a membrane liner, whereby they can also be connected tightly particularly well by means of the already described press connection.

In the case of an advantageous embodiment of the membrane liner, the first transverse direction runs orthogonally to the second transverse direction. It is attained thereby in an advantageous manner that he gas-tight and humidity-permeable membrane is flown over across an effective length, which is a large as possible. The humidity exchange can thus be realized particularly well by means of the gas-tight and humidity-permeable membrane.

In the case of an advantageous embodiment of the membrane liner, the two first apertures in the holding part are each fluidically connected to the central aperture so as to communicate therewith by means of a connecting section. The two second apertures can also each be fluidically connected to the central aperture so as to communicate therewith by means of a second connecting section. By means of these connecting sections, a distribution of the first or of the second fluid, respectively, to the first or second fluid paths, respectively, can take place particularly easily for flowing over the membrane of a membrane liner, as well as a collecting of the first or second fluid, respectively, after the fluids have flown through membrane.

A further preferred embodiment of the membrane liner provides that the first connecting sections are each formed to be open towards the upper side of the holding part. Analogously, the two second connecting sections can be formed so as to be open towards the lower side of the holding part. This embodiment of the connecting sections or of the holding parts, respectively, can be produced with particularly little effort, which is thus associated with manufacturing cost advantages.

In the case of a preferred embodiment, a spacer device is attached to the membrane of a membrane liner. The membrane or the spacer device, respectively, is fixedly connected to the holding part. This fixed connection of the membrane or of the spacer device, respectively, with the holding part is preferably attained by means of a screen printing process or by means of high-frequency welding. The position of the typically flexurally limp membrane is also ensured during operation of the humidifying module by means the spacer device in an advantageous manner. It is thus avoided that for example the membrane, which is provided with the spacer device, comes into contact with the membrane of the closest membrane liner. On the one hand, such a contact would possibly damage the membranes, and, on the other hand, reduce the effective surface for the humidity exchange via the membrane.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows an exploded illustration of a humidifying module according to the invention,

FIG. 2 shows a cross section of a humidifying module according to the invention along a stack direction of membrane liners of such a humidifying module,

FIG. 3 shows an example of a membrane liner of a humidifying module according to the invention,

FIGS. 4a to 4c show further exemplary embodiments of the membrane liners,

FIGS. 5a and 5b show examples of a closure part of the humidifying module,

FIG. 6 shows an exemplary alternative of the humidifying module comprising two humidity separators,

FIG. 7 shows an example of a section of a humidifying module with hollow-fiber membranes according to the invention,

FIG. 8 shows an example of a highly simplified, schematic representation of a fuel cell system with a humidifying module according to the invention.

### DETAILED DESCRIPTION

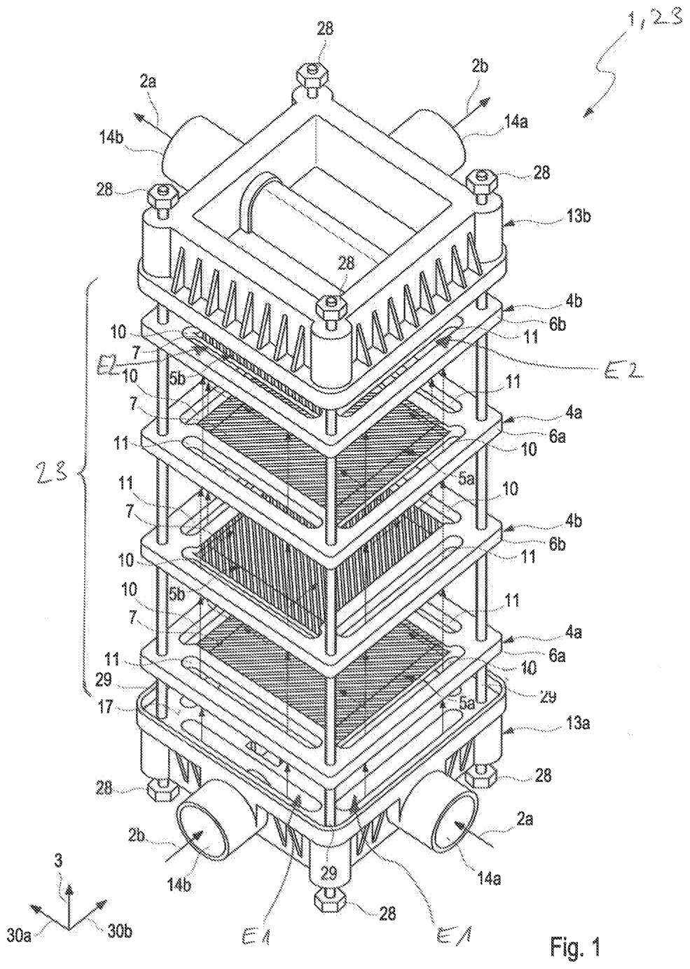

FIG. 1 shows, in an exemplary manner, a humidifying module 1 according to the invention for humidifying a fluid 2. The humidifying module 1 comprises a humidifier block 23 with a plurality of membrane liners 4. The membrane liners 4 each have a holding part 6. A gas-tight and humidity-permeable membrane 7 is in each case arranged at the holding parts 6 of the membrane liners 4. In the case of the membrane liners 4, a differentiation is to be made between first membrane liners 4a each comprising a first holding part 6a, and second membrane liners 4b each comprising a second holding part 6b, which are alternately arranged at a distance from one another along a stack direction 3. In the example of FIG. 1, all of the first membrane liners 4a comprising the first holding parts 6a and the second membrane liners 4b comprising the second holding parts 6b are embodied as identical parts. They differ from one another, however, with regard to their alignment, according to which the first membrane liners 4a comprising the first holding parts 6a are arranged so as to be rotated by 90 degrees relative to the second membrane liners 4b comprising the second holding parts 6b. Two membrane liners 4a and 4b, which are adjacent in the stack direction 3, each alternately limit a first fluid path 5a for flow-through with a first fluid 2a, and a second fluid path 5b for flow-through with a second fluid 2b. In the humidifier block 23 of the humidifying module 1, the gas-tight and humidity-permeable membranes 7 of the membrane liners 4 separate the first fluid paths 5a from the second fluid paths 5b, which are adjacent in the stack direction 3. If the first fluid 2a and the second fluid 2b now flow through the fluid paths 5a and 5b, which are fluidically separated from one another, a humidity compensation can take place between the two fluids 2a and 2b by means of the gas-tight and humidity-permeable membrane 7, without resulting in a mixing of the two fluids 2a and 2b in terms of material. The one of the fluids 2a and 2b having a lower humidity is thus humidified by absorption of the humidity of the other one of the fluids 2a and 2b, which has passed through the gas-tight and humidity-permeable membrane 7. The first fluid paths 5a and the second fluid paths 5b of the humidifying module 1 are thereby formed in such a way that the first fluid 2a and the second fluid 2b flows through them in cross flow during operation of the humidifying module 1.

Flow directions of the two fluids 2a and 2b, which cross one another, are illustrated by means of flow arrows in FIG. 1. A first fluid distribution duct 8a for distributing the first fluid 2a to the first fluid paths 5a is formed in each membrane liner 4. A first fluid collector duct 9a for collecting the first fluid 2a after flowing through the first fluid paths 5a is also formed in the membrane liners 4. To distribute the second fluid 2b, a second fluid distribution duct 8b for distributing the second fluid 2b to the second fluid paths 5b is furthermore present in the membrane liners 4. A second fluid collector duct 9b for collecting the second fluid 2b after flowing through the second fluid paths 5b is also arranged in the membrane liners 4. Each first holding part 6a advantageously has two first apertures 10 and two second apertures 11. Each second holding part 6b also comprises two first apertures 10 and two second apertures 11. As will be described in more detail in the following paragraph, the first and second apertures 10 and 11 each form subsections of the first and of the second fluid distribution duct 8a and 8b as well as of the first and of the second fluid collector duct 9a and 9b in the humidifier block 23 of the humidifying module 1.

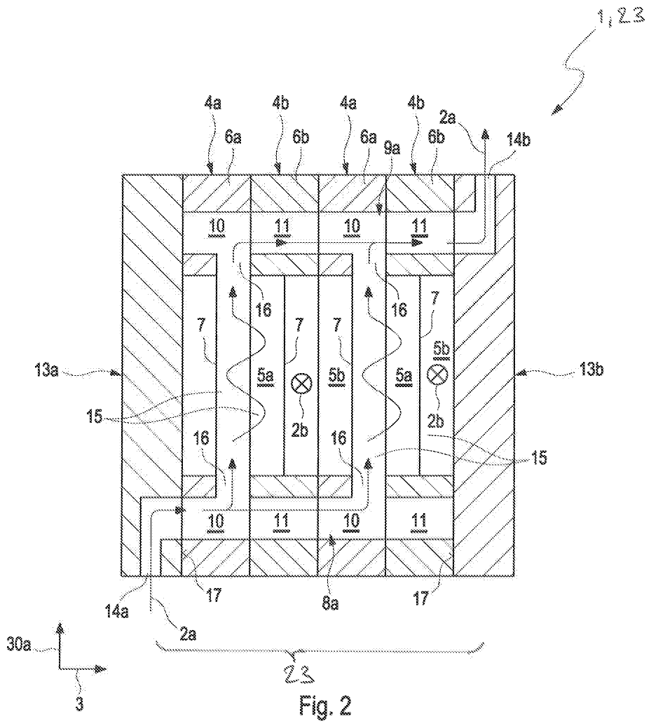

As can be seen in FIG. 2, the first fluid distribution duct 8a and the first fluid collector duct 9a are formed in the humidifier block 23 of the humidifying module 1 by means of the two first apertures 10 of the first holding parts 6a and by means of the two second apertures 11 of the second holding parts 6b.

The second fluid distribution duct 8b and the second fluid collector duct 9b are analogously formed by means of the two second apertures 11 of the first holding parts 6a and the two first apertures 10 of the second holding parts 6b. The membrane liners 4 are arranged between a first closure part 13a and a second closure part 13b. Each of the closure parts 13 thereby has a first fluid connection 14a and a second fluid connection 14b. The first fluid connection 14a of the first closure part 13a fluidically communicates with the first fluid distribution duct 8a in the humidifying module 1. The second fluid connection 14b of the first connector part 13a is connected to the second fluid distribution duct 8b so as to fluidically communicate therewith. The first fluid connection 14a of the second closure part 13b fluidically communicates with the second fluid collector duct 9b in the humidifying module 1. The second fluid connection 14b of the second closure part 13b is connected to the first fluid collector duct 9a so as to fluidically communicate therewith. According to an alternative of the humidifying module 1, at least two membrane liners 4, which are adjacent in the stack direction 3, are tightly connected to one another. The first and second fluid collector duct 9a and 9b as well as the first and the second fluid distribution duct 8a and 8b are thereby sealed against the external environment of the humidifying module 1. In a further development of the humidifying module 1, two membrane liners 4, which are adjacent to one another in the stack direction 3, can be tightly connected to one another by means of a press connection. The press connection is advantageously created by means of a screw connection, which connects the two closure parts 13a and 13b and presses the membrane liners 4 between the closure parts 13a and 13b. In FIG. 1, this screw connection is realized in an exemplary manner by means of threaded rods 29, which are received through through-bores provided for this purpose in the two closure parts 13 and the membrane liners 4. By counter-screwing nuts 28 onto the ends of the threaded rods 29 received in the afore-mentioned through-bores, the membrane liners 4 are pressed between the two closure parts 13a and 13b. It goes without saying that, alternatively, other options are also conceivable for embodying the screw connection in an expertly manner. According to a further development of the humidifying module 1, the two closure parts 13 are embodied as identical parts. The membrane liners 4 can furthermore also be formed by means of identical parts. In the example illustrated in FIG. 1, the holding part 6 of a membrane liner 4 is embodied as plate-like holding frame.

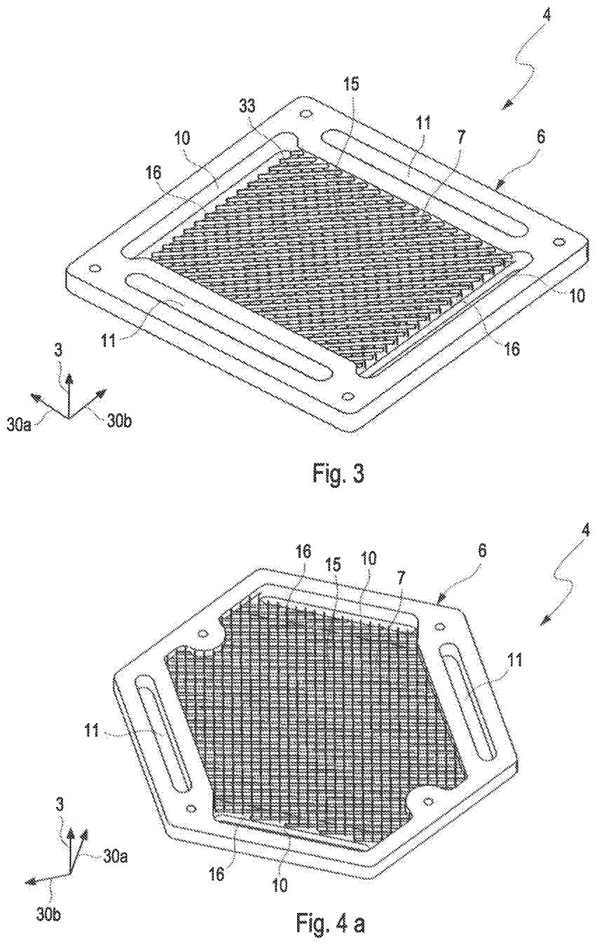

As can additionally be seen by means of FIG. 3, this holding frame has a central aperture 15. The central aperture 15 is closed in a gas-tight and humidity-permeable manner by means of the membrane 7. The central aperture 15 is arranged laterally between the two first apertures 10. The two first apertures 10 are thereby arranged at a distance from one another and at a distance from the central aperture 15 along a first transverse direction 30a of the plate-shaped holding part 6. The first transverse direction 30a runs orthogonally to the stack direction 3. The central aperture 15 of the holding part 6, which is embodied as plate-like holding frame, is furthermore arranged laterally between the two second apertures 11. The two second apertures 11 are thereby arranged at a distance from one another and at a distance from the central aperture 15 along a second transverse direction 30b of the plate-shaped holding part 6. The first transverse direction 30b runs orthogonally to the stack direction 3. In an alternative of the humidifying module 1, the first transverse direction 30a and the second transverse direction 30b run orthogonally to one another. Both of the first two apertures 10 in the holding part 6 are connected to the central aperture 15 so as to fluidically communicate therewith via a first connecting section 16 each. The two second apertures 11 can also each be connected to the central aperture 15 so as to fluidically communicate therewith via a second connecting section, which is not illustrated in the figures, however. The two first connecting sections 16 are formed to be open towards an upper side of the holding part 6, which is embodied as plate-like holding frame. The two second connecting sections can be formed so as to be open towards a lower side of the holding part 6, which is formed as plate-like holding frame, which is not illustrated in the figures, however. The first closure part 13a and the second closure part 13b each have a sealing surface 17. These sealing surfaces 17 and the cross section of at least one membrane liner 4, viewed in the stack direction 3, are embodied with an essentially identical contour.

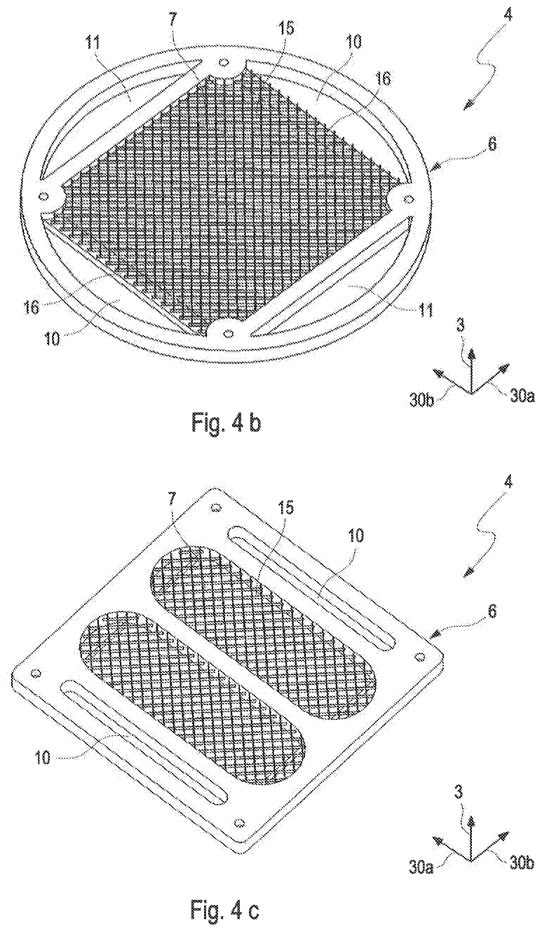

In FIGS. 1, 2, and 6, all membrane liners 4 are realized with a contour, which is mutually congruent and, viewed in the stack direction 3, essentially identical with the contour of the sealing surfaces 17 of the two closure parts 13a and 13b. This essentially identical contour of the sealing surfaces 17 of the closure parts 13 and of the cross section of the membrane liner 4, viewed in the stack direction 3, is advantageously axially- or point-symmetrically. The design options for the membrane liner 4 as illustrated in FIG. 3 and FIGS. 4a to 4c, among others, thus result. It goes without saying that a variety of further forms is known to the person of skill in the art, with which the cross section of the membrane liner 4, viewed in the stack direction 3, as well as the sealing surfaces 17 of the closure parts 13a and 13b can be embodied.

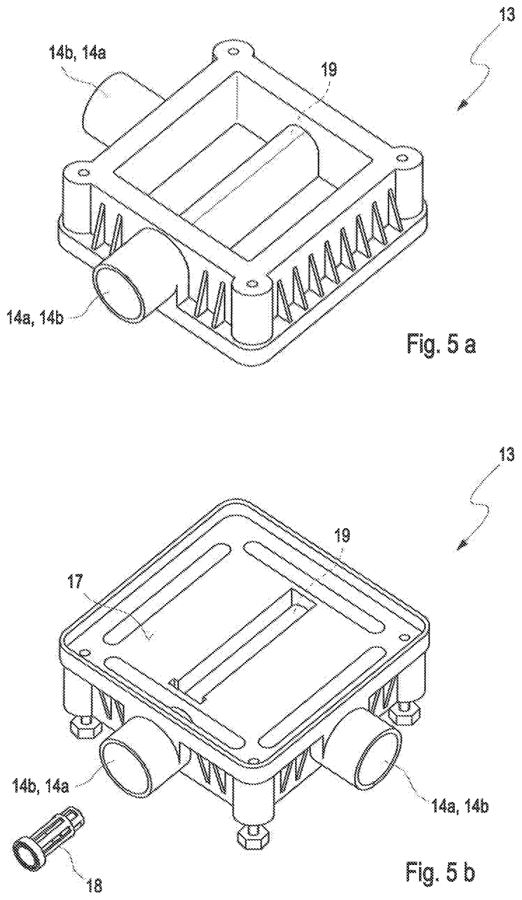

In an alternative of the humidifying module 1, the first closure part 13a, as shown in FIGS. 5a and 5b, has a bypass fluid duct 19. The bypass fluid duct 19 can be closed at least partially by means of an adjustable valve device 18. The bypass fluid duct 19 connects the first or the second fluid connection 14a or 14b, respectively, of the first closure part 13a to the first or second fluid collector duct 9a or 9b, respectively, past the first or second fluid paths 5a or 5b, respectively, so as to fluidically communicate therewith. The second closure part 13b can additionally or alternatively also comprise such a bypass fluid duct 19, which can be closed at least partially by means of an adjustable valve device 18. This bypass fluid duct 19 then connects the first or second fluid connection 14a or 14b, respectively, of the second closure part 13b to the first or second fluid distribution duct 8a or 8b, respectively, past the first or second fluid paths 5a or 5b, respectively, so as to fluidically communicate therewith.

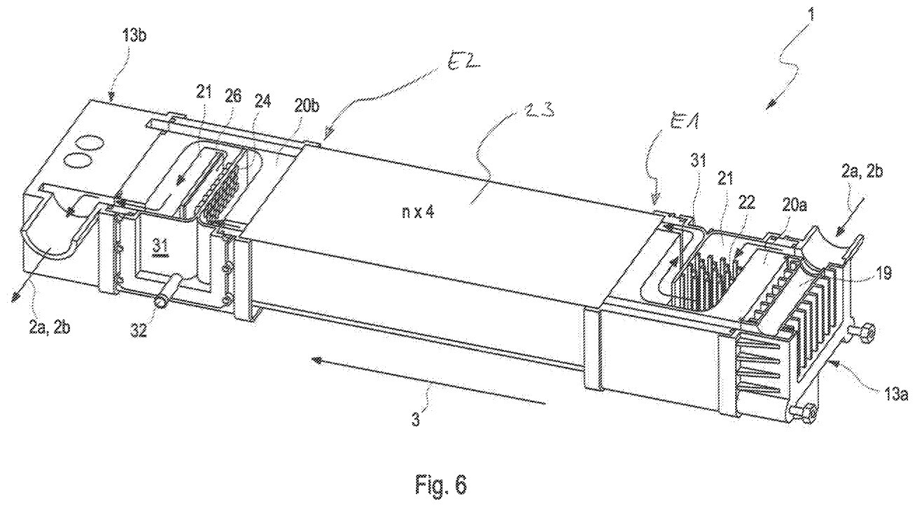

A further development of the humidifying module 1 is illustrated in an exemplary manner in FIG. 6, which provides that the humidifying module 1 comprises an additional first liquid separator 20a. This first liquid separator 20a, which can be used as pre-separator for separating liquid from the first or second fluid 2a or 2b, respectively, is arranged between the sealing surface 17 of either the first or second closure part 13a or 13b and the upper or lower side, respectively, of the closest membrane liner 4 facing the same closure part 13a or 13b. The first liquid separator 20a has a separator interior 21. The separator interior 21 of the first liquid separator 20a connects the first fluid connection 14a of the respective first or second closure part 13a or 13b, respectively, adjacent to which the first liquid separator 20a is arranged, to the first fluid distribution duct 8a so as to fluidically communicate therewith. The first liquid separator 20a can also be integrated in the respective closure part 13a or 13b. In addition to the first liquid separator 20a, the humidifying module, as illustrated in FIG. 6, can comprise a second liquid separator 20b. In the case that the first liquid separator 20a fulfills the function of a pre-separator, said second liquid separator can be used for the final separation of liquid, which is present in the first or second fluid 2a or 2b, respectively. The second liquid separator 20b is arranged between the sealing surface 17 of the respective other one of the first or second closure part 13a or 13b and the upper or lower side, respectively, of the closest membrane liner 4 facing the same respective other one of the first or second closure part 13a or 13b. The second liquid separator 20b has a separator interior 21. The separator interior 21 of the second liquid separator 20b connects the second fluid connection 14b of the respective closure part 13a or 13b, respectively, adjacent to which the second liquid separator 20b is arranged, to the first fluid collector duct 9a so as to fluidically communicate therewith. The second liquid separator 20b can also be integrated in the afore-mentioned closure part 13a or 13b. One of the liquid separators 20a or 20b, respectively, can have a fin structure 22 in its separator interior 21 for separating liquid from the first or second fluid 2a or 2b, respectively, as shown in an exemplary manner in FIG. 6 for the first liquid separator 20a. The fin structure 22 comprises a plurality of fins, which are spaced apart from one another. In the example of FIG. 6, these fins of the fin structure 22 are arranged so as to run parallel to one another and transversely to a flow direction of the first or second fluid 2a or 2b, respectively. This flow direction is illustrated by means of flow arrows. It goes without saying that further arrangement options of the fins are also possible, thus for example being arranged so as not to run parallel to one another or at an angle to the flow direction, respectively. In its separator interior 21, one of the liquid separators 20a or 20b can have a nozzle plate 24, which divides the separator interior 21. The nozzle plate 24 has at least a first acceleration opening, through which the first or second fluid 2a or 2b, respectively, is accelerated. In its separator interior 21, the afore-mentioned liquid separator 20a or 20b furthermore comprises a deflector plate 26, which is arranged at a distance from the nozzle plate 24 in such a way that the accelerated first or second fluid 2a or 2b, respectively, hits this deflector plate 26 during operation of the humidifying module 1. The nozzle plate 24 can additionally comprise at least one second acceleration opening, which can be at least partially closed by means of a settable closure element. Such a second acceleration opening comprising such a settable closure element is not shown in the figures. At least one of the liquid separators 20a or 20b advantageously has an insert member 31. The insert member 31 can have a liquid outlet 32. In an alternative of the humidifying module 1, a spacer device 33 is attached to the membrane 7 of at least one of the membrane liners 4. This spacer device 33 ensures in a stabilizing manner that the membrane 7 remains in its position during operation of the humidifying module 1. The spacer device 33 and/or the membrane 7 can be fixedly connected to the holding part 6 of the afore-mentioned membrane liner 4. The fixed connection of the spacer device 33 and/or of the membrane 7 with the holding part 6 can be attained by means of a screen printing process or high-frequency welding.

According to FIG. 7, which shows a section of a humidifying module 1 according to the invention with an alternative design of the humidifier block 23 compared to the above description, the gas-tight and humidity-permeable membranes 7 present in the humidifier block 23 can be designed as hollow-fiber membranes 34. The hollow-fiber membranes 34 can each enclose a cavity 25. The cavities 35 can each form or limit one of the first fluid paths 5a. The first fluid 2a can therefore flow through the cavities 35 along the first fluid paths 5a. The hollow-fiber membranes 34 can each limit the second fluid paths 5b on their outer sides 36, which are facing away from the cavities 35. This means that the second fluid paths 5b can be formed by spaces between the hollow-fiber membranes 34. The second fluid paths 5b can therefore be flowed through by the second fluid 2b in such a way that the second fluid 2b flows along the second fluid paths 5b through the spaces between the hollow-fiber membranes 34 and flows over the outer sides 36 of the hollow-fiber membranes 34. The hollow-fiber membranes 34 can extend along a common longitudinal direction 25. The hollow-fiber membranes 34 can essentially be arranged parallel to each other at a distance. The hollow-fiber membranes 34 can be arranged at a distance from each other in a height direction 45 of the humidifier block 23. A spacer can be provided between the hollow-fiber membranes 34 to ensure the distance between the hollow-fiber membranes 34, but this is not shown in FIG. 7 for reasons of clarity. Each of the hollow fibers 34 may have a substantially constant cross-section when viewed in the longitudinal direction of 25. The humidifier block 23 of humidifying module 1 may comprise a housing 37 extending in the longitudinal direction 25. The housing 37 may define and at least partially surround a housing interior 38. The housing interior 38 may include a central chamber 39, a fluid distributor chamber 41 and a fluid collector chamber 42. Two sealing plates 40 can be arranged in the housing interior 38. The sealing plates 40 can be arranged at a distance from each other in the longitudinal direction 25. The sealing plates 40 can divide the housing interior 38 into the fluid distributor space 41, the central chamber 39 and the fluid collector chamber 42. The fluid distributor chamber 41 and the fluid collector chamber 42 can be separated from the central chamber 39 in the longitudinal direction 25 opposite each other by the two sealing plates 40. The hollow-fiber membranes 34 can be arranged in the housing interior 38. The hollow-fiber membranes 34 can be arranged in the housing interior 38 in such a way that a central section 43 of the hollow-fiber membranes 34 is present in the central chamber 39 of the housing interior 38. In the central chamber 39, the second fluid paths 2b can be limited by the outer sides 36 in the center sections 43 of the hollow-fiber membranes 34. The hollow-fiber membranes 34 can each have two end sections 44 opposite each other in the longitudinal direction 25. The end sections 44 can each pass along the longitudinal direction into the central section 43. The two end sections 44 can each penetrate one of the sealing plates 40 in such a way that the fluid distributor chamber 41 and the fluid collector chamber 42 are fluidically connected to each other via the cavity 35 of the hollow-fiber membrane 34 concerned. The first fluid 2a can thus be distributed from the fluid distributor chamber 41 to the first fluid paths 5a defined by the cavities 35 and collected again after flowing through the first fluid paths 5a using the fluid collector chamber 42, without the first fluid 2a reaching the central chamber 39 of the housing interior 38 and thus the second fluid paths 5b. The housing 37 may have two end plates 46, one of which seals the fluid distributor chamber 41 and one of which seals the fluid collector chamber 42 fluid-tight against an external environment surrounding the humidifier block 23.

The housing 37 may have a liquid drain 47, which can be used to drain any liquid from the inside of the housing 38. Humidifying module 1 may have a first fluid connection 14a through which the first fluid 2a enters humidifying module 1 or humidifier block 23 during operation of humidifying module 1 and into the cavities 35 of the membranes 7. The first fluid 2a flowing through the cavities 35 via the first fluid paths 5a can flow out of humidifying module 1 through a second first fluid connection 14a′ of humidifying module 1. In addition, a second fluid 2b can flow through humidifying module 1 or humidifier block 23, which flows around the hollow-fiber membranes 35 on their outer sides 36. This is to say that spaces between the hollow-fiber membranes 34 can form the second fluid paths 5b for the second fluid 2b. Humidifying module 1 may have a first second fluid connection 14b through which the second fluid 2b enters humidifying module 1. The second fluid 2b can flow through a second second fluid port 14b′ of humidifying module 1 out of humidifying module 1. Here the first first fluid connection 14a and the second first fluid connection 14a′ can be arranged on humidifier sides of humidifying module 1 opposite along the longitudinal direction 25, while the second second fluid connection 14b and the second second fluid connection 14b′ can be arranged on humidifier sides of humidifying module 1 opposite in a height direction 45 running transversely to the longitudinal direction 25. The first fluid 2a can flow along the longitudinal direction 25 according to the extension of the hollow-fiber membranes 34, while the second fluid 2b flows around the hollow-fiber membranes 34 on the outside and thus has a flow direction transverse to the longitudinal direction 25, in particular in the height direction 45. The humidity-permeable design of the membranes 7 designed as hollow-fiber membranes 34 allows a humidity exchange between the first fluid 2a and the second fluid 2b. It is conceivable that the first fluid 2a will absorb humidity from the second fluid 2b. It is also conceivable that the second fluid 2b absorbs humidity from the first fluid 2a. FIG. 7 also shows that humidifying module 1 with humidifier block 23 comprising hollow-fiber membranes 34 can have a first fluid separator 20a. In addition, humidifying module 1 may include a second liquid separator 20b. The liquid separators 20a and 20b can be set up and arranged in the same way as the above example illustrated in FIG. 6. The first liquid separator 20a of humidifying module 1 can be fluidically connected to a first end section E1 of the first or second fluid paths 5a, 5b with these first or second fluid paths 5a, 5b. The second liquid separator 20b may be fluidically connected to the first or second fluid paths 5a, 5b at a second end region E2 of the first or second fluid paths 5a, 5b opposite the first end region E1, so that the first liquid separator 20a acts as a pre-separator and the second liquid separator 20b acts as a post-separator, or vice versa.

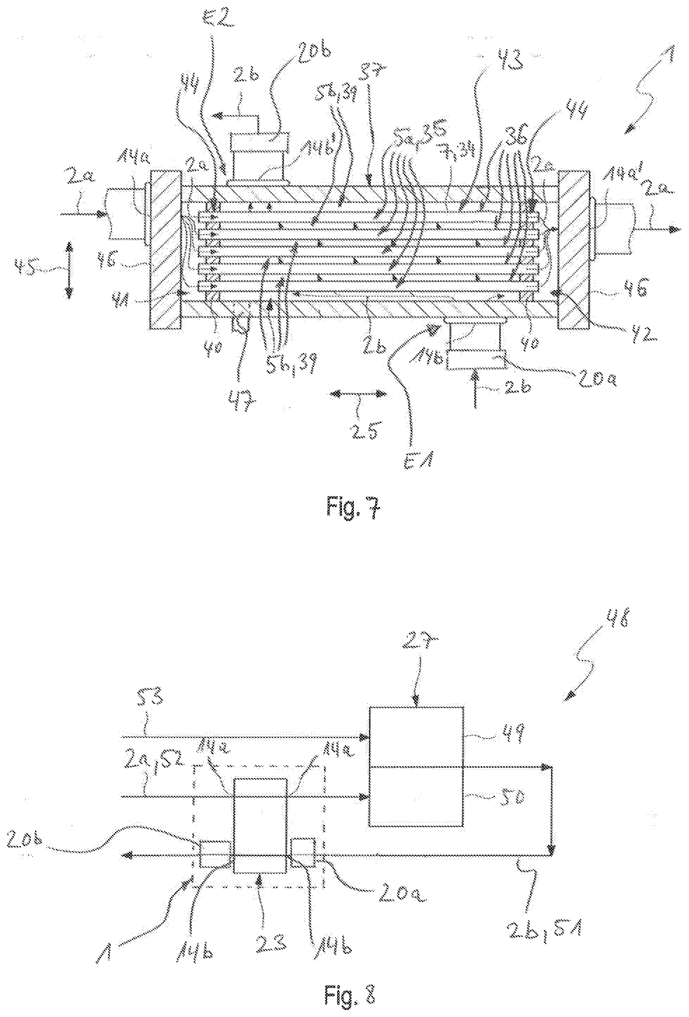

FIG. 8 shows an example of a highly simplified, schematic representation of a fuel cell system 48 with a humidifying module 1 according to the invention. The fuel cell system 48 can have a fuel cell 27 with an anode side 49 and a cathode side 50. The anode side 49 of the fuel cell 27 can be supplied with an anode gas 53, while the cathode side 50 can be supplied with a cathode gas 52. During operation of the fuel cell 27, liquid and/or gaseous water can be produced which is discharged from the fuel cell 27 together with a fuel cell exhaust gas 51. The aqueous fuel cell exhaust gas 51 can be used to humidify the cathode gas 52 by means of humidifying module 1. In the example shown, cathode gas 52 can be the first fluid 2a to flow through humidifying module 1 along first fluid paths 5a, while fuel cell exhaust gas 51 can be the second fluid 2b to flow through second fluid paths 5b through humidifying module 1. Accordingly, the fuel cell exhaust gas 1 can release humidity in the form of water or water vapor to the cathode gas 52 via the membranes 7. This prevents damage to the fuel cell 27 and/or improves the operation of the fuel cell 27.

In principle, it is also possible to use humidifying module 1 as a dehumidifier if cathode gas 52 is too humid. Excess humidity can be transferred from cathode gas 52 to the less humid fuel cell exhaust gas 51. In this case, humidity can be transferred from the first fluid 2a, i.e. from the cathode gas 52, to the second fluid 2b, i.e. to the fuel cell exhaust gas 51. It is also conceivable to use humidifying module 1 in front of a reformer of the fuel cell system 48 not shown here to generate the anode gas 53 in order to humidify a fluid or gas to be supplied to the reformer, for example air.

The scope of the present invention furthermore extends to a membrane liner 4 for a humidifying module 1, as it is illustrated in an exemplary manner in FIGS. 3 and 4a to 4c.

1-13. (canceled)

14. A humidifying module for humidifying a fluid, comprising:
a humidifier block including a plurality of first fluid paths through which a first fluid is flowable and a plurality of second fluid paths through which a second fluid is flowable;
wherein the plurality of first fluid paths and the plurality of second fluid paths in the humidifier block are fluidically separated from each other via a plurality of gas-tight and humidity-permeable membranes; and
a liquid separator fluidically connected to one of the plurality of first fluid paths for flow-through with the first fluid and the plurality of second fluid paths for flow-through with the second fluid.

15. The humidifying module according to claim 14, wherein:
the liquid separator is fluidically connected to the one of the plurality of first fluid paths and the plurality of second fluid paths at a first end portion thereof; and
further comprising a second liquid separator fluidically connected to the one of the plurality of first fluid paths and the plurality of second fluid paths at a second end portion thereof opposite to the first end portion, such that the liquid separator at the first end portion functions as a pre-separator and the second liquid separator at the second end portion functions as a post-separator, or vice versa.

16. The humidifying module according to claim 14, wherein the liquid separator has a fin structure in a separator interior for separating liquid from the respective one of the first fluid and the second fluid, wherein the fin structure includes a plurality of fins arranged at a distance from one another.

17. The humidifying module according to claim 14, wherein the liquid separator has a separator interior that is divided by a nozzle plate having at least a first acceleration opening for accelerating the respective one of the first fluid and the second fluid, and wherein a deflector plate, which the respective one of the first fluid and the second fluid accelerated from the first acceleration opening hits, is arranged in the separator interior.

18. The humidifying module according to claim 17, wherein the nozzle plate has at least a second acceleration opening that is at least partially closed via a settable closure element.

19. The humidifying module according to claim 14, wherein the plurality of membranes of the humidifier block are substantially flat and arranged in a membrane stack.

20. The humidifying module according to claim 14, wherein:
the humidifier block has a plurality of first membrane liners and a plurality of second membrane liners arranged to alternate along a stack direction at a distance from one another, wherein two membrane liners thereof that are adjacent to each other in the stack direction each alternately delimit one of the plurality of first fluid paths for flow-through with the first fluid, and, fluidically separated therefrom, one of the plurality of second fluid paths for flow-through with the second fluid,
wherein the plurality of first membrane liners and the plurality of second membrane liners each have a first holding part or a second holding part, respectively, at which one of the plurality of membranes is arranged, which separates a respective one of the first fluid paths from a respective one of the second fluid paths, which are adjacent to one another in the stack direction,
a first fluid distribution duct for distributing the first fluid to the plurality of first fluid paths, and a first fluid collector duct for collecting the first fluid after flowing through the plurality of first fluid paths, are disposed in the membrane liners, and
a second fluid distribution duct for distributing the second fluid to the plurality of second fluid paths, and a second fluid collector duct for collecting the second fluid after flowing through the plurality of second fluid paths, are disposed in the membrane liners.

21. The humidifying module according to claim 20, wherein the plurality of first membrane liners and the plurality of second membrane liners are arranged between a first closure part and a second closure part, the first closure part and the second closure part each having a first fluid connection and a second fluid connection,
wherein the first fluid connection of the first closure part fluidically communicates with the first fluid distribution duct, and the second fluid connection of the first closure part fluidically communicates with the second fluid distribution duct; and
wherein the first fluid connection of the second closure part fluidically communicates with the second fluid collector duct, and the second fluid connection of the second closure part fluidically communicate with the first fluid collector duct.

22. The humidifying module according to claim 21, wherein at least one of:
the first closure part has a bypass fluid duct that is closed at least partially via an adjustable valve device, wherein the bypass fluid duct of the first closure part connects one of the first fluid connection and the second fluid connection of the first closure part to one of the first fluid collector duct and the second fluid collector duct so as to fluidically communicate therewith, past one of the first fluid path and the second fluid path, respectively; and
the second closure part includes a bypass fluid duct that is closed at least partially an adjustable valve device, wherein the bypass fluid duct of the second closure part connects one of the first fluid connection and the second fluid connection of the second closure part to one of the first fluid distribution duct and the second fluid distribution duct so as to fluidically communicate therewith, past one of the first fluid path and the second fluid path, respectively.

23. The humidifying module according to claim 22, wherein at least one of:
a first liquid separator, comprising a separator interior that connects the first fluid connection of the first closure part to the first fluid distribution duct so as to fluidically communicate therewith, is arranged between a sealing surface of the first closure part and a side of a closest membrane liner thereto facing towards the first closure part or the first closure part comprises the first liquid separator; and
a second liquid separator, comprising a separator interior that connects the second fluid connection of the second closure part to the first fluid collector duct so as to fluidically communicate therewith, is arranged between a sealing surface of the second closure part and a side of a closest membrane liner thereto facing towards the second closure part or the second closure part comprises the second liquid separator.

24. The humidifying module according to claim 14, wherein the plurality of gas-tight and humidity-permeable membranes present in the humidifier block are hollow-fiber membranes.

25. The humidifying module according to claim 24, wherein:
the hollow-fiber membranes each surround a cavity in a sheath-like manner,
the respective cavities each define one of the plurality of first fluid paths for the first fluid, and
the hollow-fiber membranes respectively delimit the plurality of second fluid paths for the second fluid disposed on outer sides of the hollow-fiber membranes facing away from the respective cavities.

26. The humidifying module according to claim 24, wherein the hollow-fiber membranes extend along a common longitudinal direction and are substantially parallel and spaced apart to each other.

27. The humidifying module according to claim 26, wherein:
the humidifier block includes a housing extending in the longitudinal direction and defining a housing interior space,
a fluid distributor chamber and a fluid collector chamber are structured and arranged separated in a fluid-tight manner from a central chamber of the housing interior opposite to one another in the longitudinal direction via two sealing plates,
the hollow-fiber membranes arranged in the housing interior space such that a central section of the hollow-fiber membranes is present in the central chamber of the housing interior space, the central section of the hollow-fiber membranes respectively delimiting the plurality of second fluid paths on the outer sides of the hollow-fiber membranes, and
wherein the hollow-fiber membranes penetrate the two sealing plates in end sections of the hollow-fiber membranes that lie opposite to one another along the longitudinal direction and respectively merge into the central section along the longitudinal direction, such that the fluid distributor chamber and the fluid collector chamber are fluidically connected to one another via the respective cavities of the hollow-fiber membranes defining the plurality of first fluid paths.

28. The humidifying module according to claim 15, wherein the second liquid separator has a separator interior including a plurality of fins arranged at a distance from one another.

29. The humidifying module according to claim 20, wherein the plurality of membranes of the humidifier block are substantially flat and arranged in a membrane stack.

30. The humidifying module according to claim 22, wherein the liquid separator has a separator interior that connects the first fluid connection of the first closure part to the first fluid distribution duct so as to fluidically communicate therewith, and the liquid separator is arranged between a sealing surface of the first closure part and a side of a closest membrane liner thereto facing towards the first closure part.

31. The humidifying module according to claim 22, wherein the liquid separator has a separator interior that connects the second fluid connection of the second closure part to the first fluid collector duct so as to fluidically communicate therewith, and the liquid separator is arranged between a sealing surface of the second closure part and a side of a closest membrane liner thereto facing towards the second closure part.

32. A humidifying module for humidifying a fluid of a fuel cell, comprising:
a humidifier block including a plurality of first fluid paths through which a first fluid is flowable and a plurality of second fluid paths through which a second fluid is flowable;
a plurality of gas-tight and humidity-permeable membranes structured and arranged to fluidically separate the plurality of first fluid paths and the plurality of second fluid paths from each other in the humidifier block, wherein the plurality of gas-tight and humidity-permeable membranes comprise hollow-fiber membranes; and
a liquid separator fluidically connected to one of the plurality of first fluid paths for flow-through with the first fluid and the plurality of second fluid paths for flow-through with the second fluid.

33. The humidifying module according to claim 31, wherein the hollow-fiber membranes are structured and arranged to extend substantially parallel and spaced apart to each other.
